(19) United States
(12) Patent Application Publication
(10) Pub. No.: US 2004/0109975 A1
(43) Pub. Date: Jun. 10, 2004

(54) Core structure

(76) Inventors: Jouni Lindroos, Raisio (FI); Kari Hakko, Paimio (FI)

Correspondence Address: NIXON & VANDERHYE, PC, 1100 N GLEBE ROAD, 8TH FLOOR, ARLINGTON, VA, 22201-4714, US

(21) Appl. No.: 10/399,113

(22) PCT Filed: Oct. 26, 2001
(86) PCT No.: PCT/FI01/00931

(30) Foreign Application Priority Data
Oct. 27, 2000 (FI) 20002373

(51) Int. Cl. B32B 3/02

(52) U.S. Cl. 428/66.6

(57) ABSTRACT

The invention relates to a core structure used is chokes, transformers and the like, the core of the core structure being at lest generally ring-like and provided with at least one gap. Both within the core and outside the core there is at least one sleeve. The outer and inner sleeves, which regarding the core are located axially mainly at the same location, are arranged to keep the core cohesive so that said parts do not move regarding each other.

The invention relates to a core structure which is presented in the preamble of claim 1 and which is used in chokes, transformers and the like, the core of the core structure being at least generally ring-like and provided with at least one gap.

Chokes, transformers and the like are often used in electro technical equipment for reducing or eliminating different electrical interferences, for instance in filter circuits, and also for converting the voltage of an electrical current to a higher or lower value, and also for galvanic isolators. Around the core there are one or more coils, usually of lacquer coated copper wire. As such components are used particularly in other than direct-current applications, there is a disadvantage in that such components often generate noise, particularly due to some resonance. Because the noise may be quite annoying in many applications, it has been an aim to prevent the noise generation by a structural approach.

The publication U.S. Pat. No. 5,581,224 presents a core structure, where the ring contains a number of spools. However, a structure of this kind is quite complicated and expensive to manufacture. One solution is to weld the plate layers of the core to each other at some points, e.g. by spot welding or by TIC welds, but even during careful welding the core of the spool will become quite strongly heated, there may occur burrs or other harmful results. Welding work in general will easily cause smoke and the like, which is usually harmful. The shape of the component may also change somewhat, which generally is quite harmful regarding the next operation stages. Also the electrical characteristics will change to some degree. There is also known a structure where a ring core wound of a band is hardened with a resin or some other adhesives. The formed gap can be filled with an isolating body and/or with a hardening stuff. However, such solutions have proved rather cumbersome in serial production, and neither has it always been possible to eliminate the noise problems. Further the structure is mechanically somewhat weak, and with time it will become brittle.

The publication JP 59148314 presents a solution where a thin band is used on the outer periphery to compress the core. The compression force is generated by a screw and nut, which may be inconvenient and provide a rather inefficient compression. The publication JP 63237511 presents the use and the heat treatment of a non-magnetic metal tape, and it states that the heat treatment is extended to the level of 400 or 600, even to 800° C., even though said tape is used keep the core cohesive by winding the tape around the core in a toroidal fashion. For binding the outer periphery the publication JP 11176649 uses a binding strip, which is tightened by a spring and which extends over a portion of the periphery. With the aid of a multi-component solution it is also possible to arrange a fastening member, even though the solution is obviously expensive.

The object of the invention is to provide a core structure used in chokes, transformers and the like, the core of the core structure being at least generally ring-like and provided with at least one gap, but which is almost noiseless during operation. A further object of the invention is to present a core structure, which could be manufactured in a rapid and advantageous manner, and which would operate reliably during its whole operating life.

The object of the invention is achieved in the manner presented in the characterising part of the claim 1. If in chokes, transformers and the like there is at least one sleeve, both within the core and outside the core, and if the outer and inner sleeves, which regarding the core are located axially mainly at the same location, are arranged to keep the core cohesive so that said parts do not move regarding each other, then a structure is obtained which firmly binds said parts to each other. Then also no part of the assembled whole thus formed will be able to vibrate, and thus no noise will be created, at least no annoyingly loud noise, or even no noise at all, which could be perceived by the human ear.

If said sleeves are of a magnetically non-conducting material, or at least magnetically poorly conducting material, then the sleeves do not interfere with the operation of the choke, transformer or the like.

If the wall thickness of the sleeves is at least 1/10 of the sleeve's largest outer dimension, preferably less than 1/20 of the sleeve's largest outer dimension, then quite little sleeve material is used, and the sleeves do not substantially add to the cross-section of the core, and neither do the sleeves push the coil substantially farther away from the core in either direction.

If the sleeves cover at least half of the peripheral areas of the core, then the sleeves will support by quite a large portion the core's inner and outer periphery, and therefore this will generate quite little noise.

If the cohesive effect of the sleeves has been provided by cold working, for instance in a manner resembling bulge lathing, then the operation stage is quite short in serial production, and therefore cheap regarding the costs. Neither will there occur problems caused by a strong momentary heating, as is often the case in welded structures. Sleeves made by cold working will also withstand stresses caused by heating of the component during the operation.

If the cohesive effect of the sleeves on the core is provided by adding a hardening substance at the contact surfaces of the core and the sleeves, then also this will create a quite noiseless and mechanically durable structure. Then no special machine is required, as for instance in cold working.

If the cohesive effect of the sleeves on the core is provided by using a hydraulic press or the like to press the components in there places, then the parts can be dimensioned to be suitably tight regarding each other, which in a short operating stage will provide a very reliable and durable joint structure. Hydraulic presses are easily available, and their use is simple also in serial production.

If the core is divided into at least two parts with the aid of gaps, this provides a structure with the required gaps, but the structure is nevertheless strong and durable.

If said parts are of an at least almost similar size, this provides a symmetrical structure, which regarding the electric characteristics often is the best possible in components of this type.

If the core gap contains at least mainly only air, there is no body in the gap which would be able to resonate.

The invention is described below in more detail with reference to the enclosed drawing, where

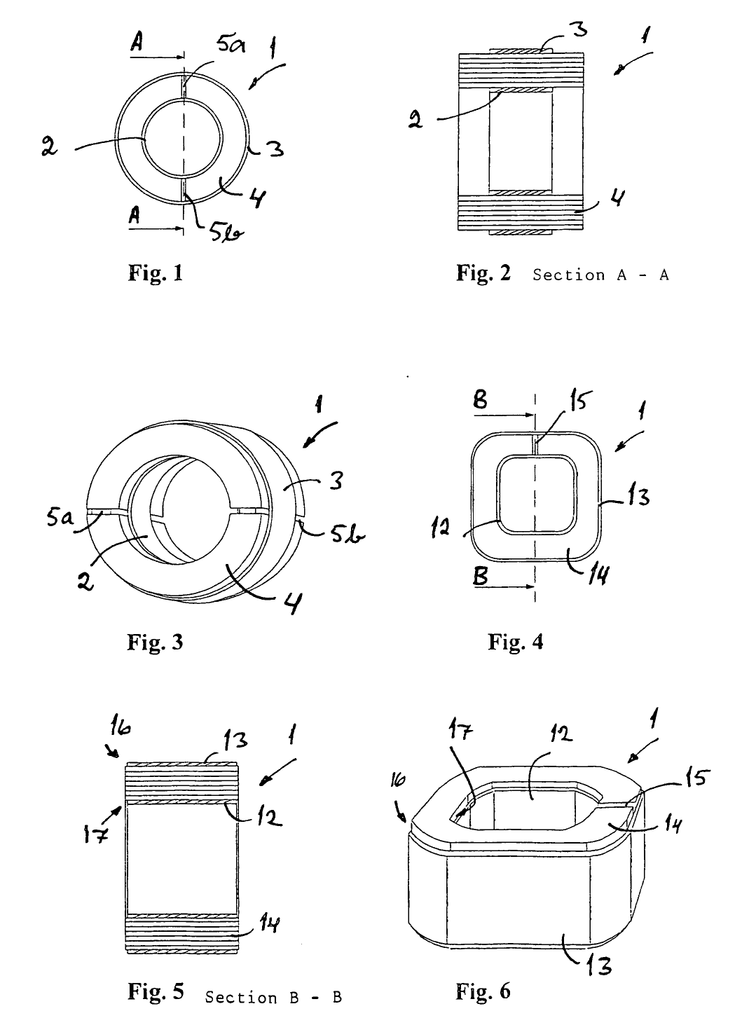

FIG. 1 shows schematically a core structure according to the invention seen from one end,

FIG. 2 shows schematically the core structure according to FIG. 1, enlarged and in the cross-section A-A,

FIG. 3 shows schematically the structure according to FIG. 1 as a three-dimensional illustration,

FIG. 4 shows schematically a core structure, which has the shape of a square with rounded corners,

FIG. 5 shows schematically the core structure according to FIG. 4, enlarged and in the cross-section B-B, and

FIG. 6 shows schematically the core structure according to FIG. 4 as a three-dimensional illustration.

In FIG. 1 the reference number represents a core arrangement which comprises an internal sleeve 2 and an external sleeve 3, and between them a ring-like core 4. Gaps 5a and 5b are arranged in the core, but in some applications there may be no gaps at all, or there might be even more gaps. The gaps 5a and 5b of the core 4 can be formed by a conventional method, such as cold sawing, or e.g. with water jet cutting. Usually one gap is formed so that the gap extends from the first end surface of the core 4 to the second end surface, mainly in a straight line, but even an axially inclined gap could be used, when desired. It is also possible to use a pair of gaps, where the first gap extends in a straight or inclined manner from the first end surface axially approximately halfway, or even a little farther, toward the second end surface, and that correspondingly the second gap extends in a straight or inclined manner from the second end surface axially approximately halfway, or even a little farther, toward the first end surface, but that at least a portion of the core 4 is left like a neck (not shown) between the first and second gaps in the gap pair.

FIG. 2 shows a cross-section in the direction A-A of FIG. 1. The outer sleeve 3 and the inner sleeve 2 have in this application a length, which is about half of the ring-like core's 4 axial length, but the sleeves 2 and 3 can also have different lengths in some applications. In the solution according to FIG. 2 the sleeves 2 and 3 are located almost at the centre of the core in its longitudinal direction, but also other solutions may be used. The core 4 is made of steel band by winding cylindrically several band layers on top of each other. In FIG. 2 only a few band layers are shown for the sake of clarity, because in small transformers, chokes or the like the band is relatively thin, e.g. 0.2 to 0.6 mm. Of course the band may have also some other thickness. The core 4 can also be constructed of other materials, such as for instance ferrite or some sintered or amorphous materials. Compared to the diameter of the core the sleeves 2 and 3 have a thickness which is rather small, less than 1/10, preferably less than 1/20 of the largest external measurement of the sleeve 3. If the outer sleeve 3 has a large outer diameter, for instance 90 mm, it is recommendable to use a sleeve with a thickness of about 2 mm. Then the corresponding ratio is about 1/45. Then the sleeves 2 and 3 require quite little space, and therefore the coil, which is later made around the core structure 1, will not be hardly larger at all, and thus the amount of coil wire will not be much higher. It is not recommendable to make the sleeve of too thin a material, in order to keep the sleeve intact when it is pressed in its place.

The material of the sleeves is a magnetically non-conducting material, or at least a poorly conducting material. Materials in question are i.a. austenitic steel alloys, aluminium or alloys thereof, even some types of plastic or glass fibre compounds or composite structures, if the temperature of the application in question in a choke, transformer or the like, will not rise too high regarding the environment and/or the device in question. One very recommendable material for the sleeve is acid-proof stainless steel, according to the standard AISI 316 or the like. It is commercially available as tubes, from which it is easy to cut suitable pieces and make them into sleeves for instance by a vibration grinding pre-treatment.

The gaps 5a, 5b are usually made once the core 4 is wound into its final form and sealed with a resin or some other adhesive. The width of the gaps 5a, 5b can be for instance 1 to 3 mm in small transformers, chokes or the like, but of course also other gap widths can be chosen. FIG. 2 shows that the inner sleeve 2 and the outer sleeve 3 are in a tight contact with the core 4.

A recommendable wall thickness for the sleeves 2, 3 is the commercially easily available size 1.5 or 2 mm, when cores of this size is manufactured, so that the outer diameter of the inner sleeve 2 is 33 to 40 mm and the outer diameter of the outer sleeve 3 is 68 to 89 mm. Some applications use a hydraulic press to press the components into their places. This is a quite rapid manufacturing method, even if the required press force is up to 2 MN. Therefore, it must be secured that the manufacturing of the desired press or chasing fitting is possible by selecting the cross-sectional area of the material 2, 3 in the sleeves to be so large that the allowed surface pressure will not be exceeded in the mounting phase. In order to obtain a core structure which in all respects is of high quality it is recommended to make a careful design of the fitting and to define suitable tolerances.

One manufacturing method is to use cold working, so that the outer sleeve 3 is rolled with the aid of rolls to a smaller size, in a manner which is used in so-called bulge lathing. This is possible particularly if the core 4 is cylindrical. Another way is to use some hardening substance on the contacting surfaces between the sleeves 2 and 3 and the core 4, and even at the ends of the sleeves. However, it must be observed that if there are two or more gaps 5a, 5b, then it must be secured that these gaps obtain the desired widths.

FIG. 3 shows a core structure according to the invention as a three-dimensional illustration. It must be observed how thin the sleeves 2, 3 are compared to the core structure 1, and how mechanically strong such a core structure is, which is bound by such sleeves.

FIG. 4 presents a core structure 1 which has approximately the form of a square with rounded corners. Thus the form of the core 14 can differ from a cylindrical form, but in that case the form of the inner sleeve 12 and the outer sleeve 13 must follow the forms of the core 14 in a corresponding manner. This structure shows only one gap 15, but also other numbers could be applied when deemed necessary.

FIG. 5 shows the cross-section B-B of FIG. 4, and it illustrates how the sleeves 12 and 13 in this application are axially only slightly shorter than the axial length of the core 14. Small steps are left in the corners 16 and 17, which can be utilised to keep the ring-like caps (not shown) in their places where they protect the ends of the core structure 1 before the winding. If the sleeves 12 and 13 cover the peripheral surfaces of the core 14, either over a large part or even completely, then the core 14 can hardly vibrate and generate noise. The same applies of course to all core structures 1 according to the invention, whether they have a ring-like structure, a cylindrical structure or some other applicable form.

FIG. 6 shows the solution of FIG. 4 as a three-dimensional illustration before the winding and any other preparatory actions, which may be for instance the mounting of protecting end caps, the protecting of the peripheral surfaces at least partly in some manner, for instance with a plastic film or coating, and so on. The coil wire surface is of course provided with one or more lacquer layers, but often it is considered necessary to protect the core structure in order to prevent short circuits, harmful conduction or the like. It is conceivable that the protective end cap extends a long distance so that it also protects the peripheral surfaces.

The number of sleeves may vary in different applications. It is conceivable that there is for instance two outer sleeves, and that they are located close to the end regions. The same idea can be applied regarding the inner sleeves. The inner and outer sleeves can also be of different materials.

The invention is not restricted to the enclosed embodiment, but many modifications of it are conceivable within the scope of the enclosed claims.

1. A core structure used in chokes, transformers and the like, the core of the core structure being at least generally ring-like and provided with at least one gap, characterised in that there is at least one sleeve, both within the core and outside the core, and that the outer and inner sleeves, which regarding the core are located axially mainly at the same location, are arranged to keep the core cohesive so that said parts do not move regarding each other.

2. A core structure according to claim 1, characterised in that said sleeves are of a magnetically non-conducting material, or at least magnetically poorly conducting material.

3. A core structure according to claim 2, characterised in that the wall thickness of the sleeves is at least 1/10 of the sleeve's largest outer dimension, preferably less than 1/20 of the sleeve's largest outer dimension.

4. A core structure according to claim 3, characterised in that the sleeves cover at least half of the peripheral areas of the core.

5. A core structure according to claim 4, characterised in that the cohesive effect of the sleeves has been provided by cold working.

6. A core structure according to claim 4, characterised in that the cohesive effect of the sleeves on the core is provided by adding a hardening substance at the contact surfaces of the core and the sleeves.

7. A core structure according to claim 4, characterised in that the cohesive effect of the sleeves on the core is provided by using a hydraulic press or the like to press the components in there places.

8. A core structure according to any previous claim, characterised in that the core is divided into at least two parts with the aid of gaps.

9. A core structure according to claim 8, characterised in that said pails are of an at least approximately equal size.

10. A core structure according to any previous claim, characterised in that core gap contains at least mainly only air.
